(19) United States
(12) Patent Application Publication
(10) Pub. No.: US 2026/0134241 A1
(43) Pub. Date: May 14, 2026

(54) METHOD, APPARATUS, ELECTRONIC DEVICE, MEDIUM, AND PRODUCT FOR DISPLAYING INFORMATION

(71) Applicant: MATRIXED REALITY TECHNOLOGY CO., LTD., Wuxi (CN)

(72) Inventors: Can Cui, Beijing (CN); Lu Wang, Beijing (CN)

(21) Appl. No.: 19/121,806

(22) PCT Filed: Oct. 24, 2023
(86) PCT No.: PCT/CN2023/126175

§ 371 Date: Apr. 17, 2025

(30) Foreign Application Priority Data
Oct. 24, 2022 (CN) 202211303699.X

(51) Int. Cl. G06K 7/14; G06Q 30/0601; G06T 15/06; G06T 15/20

(52) U.S. Cl. CPC G06K 7/1417; G06Q 30/0641; G06T 15/06; G06T 15/20; G06T 2200/24; G06T 2210/21

(57) ABSTRACT

The present application discloses a method and apparatus for displaying information, an electronic device, a medium, and a product. A specific implementation solution is: displaying a to-be-recognized code scanner in a virtual space of a head-mounted display device, the to-be-recognized code scanner being configured with a corresponding virtual camera; performing parameter setting on the virtual camera based on display parameters of the to-be-recognized code scanner; acquiring a captured image of the virtual space captured by the virtual camera with set parameters; and displaying, in the virtual space, a recognition processing result of a to-be-recognized code in the captured image.

The present disclosure claims priority to Chinese Patent Application No. CN202211303699.X, filed with the China National Intellectual Property Administration on Oct. 24, 2022, and entitled “Method, Apparatus, Electronic Device, Medium, and Product for Displaying Information”, which is incorporated herein by reference in its entirety.

### TECHNICAL FIELD

The present disclosure relates to the technical field of head-mounted display devices, and in particular to a method, apparatus, electronic device, medium, and product for displaying information.

### BACKGROUND

Head-mounted display devices using technologies such as augmented reality (AR) and virtual reality (VR) are becoming increasingly widespread. When a head-mounted display device displays contents, the contents displayed by the head-mounted display device may include a to-be-recognized code (e.g., a one-dimensional code, a two-dimensional code, etc.). In some cases, a user may have a need for recognition of the to-be-recognized code.

### SUMMARY

Embodiments of the present disclosure provide a method, apparatus, electronic device, medium, and product for displaying information.

According to an aspect of embodiments of the present disclosure, a method for displaying information is provided. The method includes: displaying a to-be-recognized code scanner in a virtual space of a head-mounted display device, the to-be-recognized code scanner being configured with a corresponding virtual camera; setting parameters of the virtual camera based on display parameters of the to-be-recognized code scanner; acquiring a captured image of the virtual space captured by the virtual camera with set parameters; and displaying, in the virtual space, a recognition processing result of a to-be-recognized code in the captured image.

According to another aspect of embodiments of the present disclosure, an apparatus for displaying information is provided. The apparatus includes: a first display module configured to display a to-be-recognized code scanner in a virtual space of a head-mounted display device, the to-be-recognized code scanner being configured with a corresponding virtual camera; a setting module configured to set parameters of the virtual camera based on display parameters of the to-be-recognized code scanner; an acquisition module configured to acquire a captured image of the virtual space captured by the virtual camera with set parameters; and a second display module configured to display, in the virtual space, a recognition processing result of a to-be-recognized code in the captured image.

According to yet another aspect of embodiments of the present disclosure, an electronic device is provided. The electronic device includes: a processor; and a memory configured to store processor executable instructions, wherein the processor is configured to read the executable instructions from the memory and execute the instructions to implement the method for displaying information described above.

According to still another aspect of the present disclosure, a computer-readable storage medium is provided. The computer-readable storage medium stores a computer program therein, wherein the computer program is configured to execute the method for displaying information described above.

According to a further aspect of the present disclosure, a computer program product is provided. The computer program product includes computer program instructions, wherein the computer program instructions, when executed by a processor, implements the method for displaying information described above.

The technical solution of the present disclosure is further described in detail below in conjunction with the accompanying drawings and embodiments.

### BRIEF DESCRIPTION OF THE DRAWINGS

The above and other objects, features and advantages of the present disclosure will become more apparent from more detailed description of embodiments of the present disclosure in conjunction with the accompanying drawings. The accompanying drawings are used to provide further understanding of embodiments of the present disclosure, and form part of the specification, and are used, together with embodiments of the present disclosure, for explaining the present disclosure, but do not limit the present disclosure. In the accompanying drawings, same reference numerals usually represent same components or steps.

FIG. 1 is a flow diagram of a method for displaying information provided in an exemplary embodiment of the present disclosure.

FIG. 2-1 is a schematic diagram of a virtual space in a method for displaying information provided in an exemplary embodiment of the present disclosure.

FIG. 2-2 is another schematic diagram of a virtual space in a method for displaying information provided in an exemplary embodiment of the present disclosure.

FIG. 3 is a flow diagram of a method for displaying information provided in another exemplary embodiment of the present disclosure.

FIG. 4 is a flow diagram of a method for displaying information provided in yet another exemplary embodiment of the present disclosure.

FIG. 5 is a flow diagram of a method for displaying information provided in still another exemplary embodiment of the present disclosure.

FIG. 6 is a flow diagram of a method for displaying information provided in still yet another exemplary embodiment of the present disclosure.

FIG. 7 is a flow diagram of a method for displaying information provided in a further exemplary embodiment of the present disclosure.

FIG. 8 is a structural diagram of an apparatus for displaying information provided in an exemplary embodiment of the present disclosure.

FIG. 9 is a structural diagram of an apparatus for displaying information provided in another exemplary embodiment of the present disclosure.

FIG. 10 is a structural diagram of an apparatus for displaying information provided in yet another exemplary embodiment of the present disclosure.

FIG. 11 is a structural diagram of an apparatus for displaying information provided in still another exemplary embodiment of the present disclosure.

FIG. 12 is a structural diagram of an apparatus for displaying information provided in still yet another exemplary embodiment of the present disclosure.

FIG. 13 is a structural diagram of an apparatus for displaying information provided in a further exemplary embodiment of the present disclosure.

FIG. 14 is a structural diagram of an electronic device provided in an exemplary embodiment of the present disclosure.

### DETAILED DESCRIPTION

Exemplary embodiments according to the present disclosure will be described below in detail with reference to the accompanying drawings. Obviously, the described embodiments are only part of, instead of all of embodiments of the present disclosure. It should be understood that the present disclosure is not limited by the exemplary embodiments described here.

It is to be noted that unless specifically stated otherwise, the relative arrangement of components and steps, numerical expressions and numerical values set forth in these embodiments do not limit the scope of the present disclosure.

It may be understood by those skilled in the art that the terms “first”, “second” and the like in the embodiments of the present disclosure are only used to distinguish between different steps, devices or modules, etc., and do not represent any particular technical meaning or indicate an inevitable logical order thereof.

It should also be understood that in embodiments of the present disclosure, “plurality” may refer to two or more, and “at least one” may refer to one, two, or more.

It should also be understood that the number of any component, data, or structure mentioned in embodiments of the present disclosure may generally be understood to be one or more, unless explicitly defined or indicated otherwise by the context.

Additionally, the term “and/or” in the present disclosure merely represents an association relationship describing associated objects, indicating there may be three relationships. For example, A and/or B may indicate three situations: A exists alone; both A and B exist; and B exists alone. Additionally, the character “/” in the present disclosure generally indicates that the associated objects prior to and following it are in an “or” relationship.

It should also be understood that description of the various embodiments in the present disclosure emphasizes differences between the various embodiments. For their identical aspects or similarities, reference may be made to each other, and for the sake of brevity, they will not be described repeatedly.

Furthermore, it should be appreciated that, for ease of description, the sizes of various parts shown in the drawings are not drawn according to actual proportional relationships.

The following description of at least one exemplary embodiment is actually only illustrative, and in no way serves as any limitation on the present disclosure and its application or use.

Technologies, methods, and devices known to those of ordinary skill in the related art may be not discussed in detail, but where appropriate, the technologies, methods, and devices should be regarded as part of the specification.

It should be noted that similar reference numerals and letters denote similar items in the following drawings, so once a certain item is defined in one drawing, it does not need to be further discussed in subsequent drawings.

Embodiments of the present disclosure may be applied to electronic devices such as terminal devices, computer systems, servers, etc., which may operate with numerous other general-purpose or specialized computing system environments or configurations. Examples of well-known terminal devices, computing systems, environments, and/or configurations suitable for use with electronic devices such as terminal devices, computer systems, servers, etc. include, but are not limited to: personal computer systems, server computer systems, thin clients, thick clients, handheld or laptop devices, microprocessor-based systems, set-top boxes, programmable consumer electronics, network personal computers, minicomputer systems, mainframe computer systems, and distributed cloud computing technology environments that include any system described above, and so on.

Electronic devices such as terminal devices, computer systems, servers, etc. may be described in the general context of computer system executable instructions (such as program modules) executed by a computer system. Typically, program modules may include routines, programs, target programs, components, logic, data structures, and so on, which perform specific tasks or implement specific abstract data types. The computer systems/servers may be implemented in a distributed cloud computing environment, in which tasks are performed by remote processing devices linked through a communication network. In the distributed cloud computing environment, the program modules may be located on a local or remote computing system storage medium that includes a storage device.

### Exemplary Method

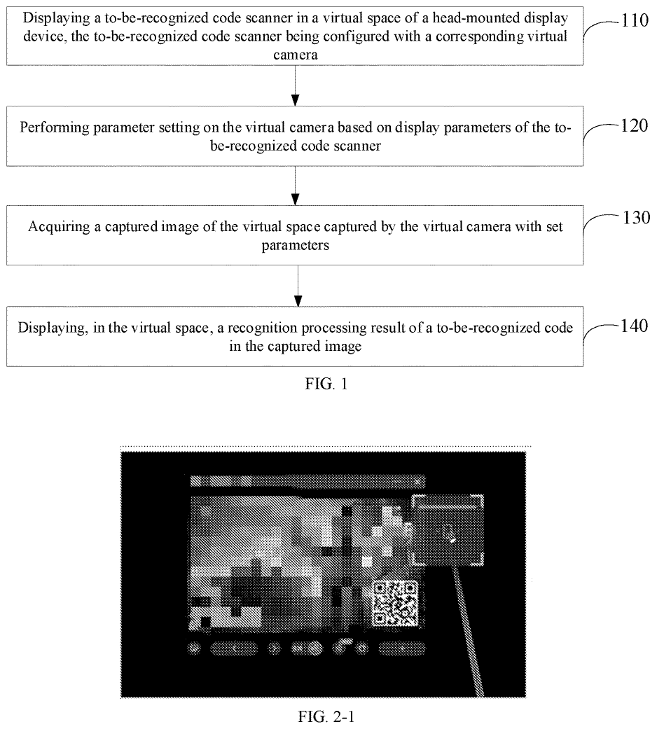

FIG. 1 is a flow diagram of a method for displaying information provided in an exemplary embodiment of the present disclosure. The method shown in FIG. 1 may include step 110, step 120, step 130, and step 140. The steps will be described below respectively.

Step 110, displaying a to-be-recognized code scanner in a virtual space of a head-mounted display device, the to-be-recognized code scanner being provided with a corresponding virtual camera.

It is to be noted that the head-mounted display device may also be referred to as a head-mounted display (HMD) or simply HMD. The head-mounted display device may be used to achieve an AR effect, a VR effect, a mixed reality (MR) effect, etc. As the head-mounted display device can create a unique sense of immersion, a user can subjectively feel as if being in a three-dimensional space isolated from reality when using the head-mounted display device. This three-dimensional space is the virtual space of the head-mounted display device. Optionally, the head-mounted display device may be AR glasses, VR glasses, MR glasses, or the like.

In step 110, an executor for running the method for displaying information described above may display the to-be-recognized code scanner at any position in the virtual space specified by the user according to the user's actual need.

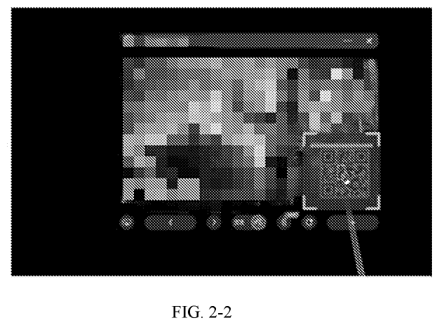

Optionally, the to-be-recognized code scanner may be a rectangular scanning frame as shown in FIG. 2-1 or FIG. 2-2 (with a pattern of a mobile phone and a pattern of a hand operating the mobile phone in the middle). Of course, the to-be-recognized code scanner may also be a scanning frame of other shapes (such as a circular scanning frame, a rhombic scanning frame, etc.), or a scanner in a form other than the scanning frame, which will not be listed here.

Optionally, the above-mentioned executor may render an image using a Unity engine (which is a cross-platform engine that includes graphic, sound or other functions) or the like, so that the rendered image can be displayed in the virtual space. In this case, the above-mentioned executor may create the above-mentioned virtual camera through an engine such as Unity. Of course, the above-mentioned virtual camera may also be added in other implementable ways. For example, the above-mentioned executor may also be a virtual camera for the to-be-recognized code scanner constructed by another three-dimensional rendering engine, which will not be listed here.

It is to be noted that the relationship between the to-be-recognized code scanner and the virtual camera may be understood as follows: the to-be-recognized code scanner is configured to indicate, in an explicit form (i.e., the to-be-recognized code scanner is visible to the user), an area selected by the user for scanning, and the virtual camera is configured to capture, in an implicit form (i.e., the virtual camera may be invisible to the user), the area selected by the user for scanning. That is, both the to-be-recognized code scanner and the virtual camera are associated with the area selected by the user. Thus, the user's operation (e.g., manipulating a handheld controller as described below) can influence both the to-be-recognized code scanner and the virtual camera (e.g., influencing the display of the to-be-recognized code scanner and the image capturing by the virtual camera).

Step 120, setting parameter of the virtual camera based on display parameters of the to-be-recognized code scanner.

Optionally, the display parameters of the to-be-recognized code scanner include, but are not limited to, display position, display orientation, display size, display color, etc.

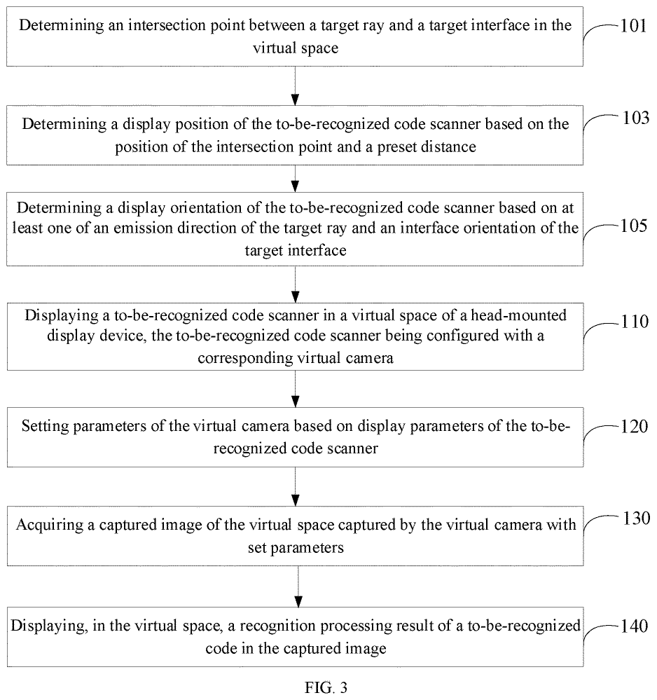

Optionally, there may be a specific association relationship between the display parameters of the to-be-recognized code scanner and working parameters of the virtual camera (specifically referring to the relevant description of the embodiment shown in FIG. 3 below). In step 120, through the use of the association relationship, the working parameters of the virtual camera may be obtained from the display parameters of the to-be-recognized code scanner, and then, parameter setting may be performed on the virtual camera so that the virtual camera works according to the working parameters.

Step 130, acquiring a captured image in the virtual space captured by the virtual camera with set parameters.

In step 130, after the parameter of the virtual camera is set, the virtual camera may be invoked to capture the virtual space, to obtain a captured image that includes part of contents in the virtual space.

It is to be noted that spatial information of the virtual space may be used to indicate what contents are displayed in the virtual space, where the contents are displayed, and in what attitudes the contents are displayed, etc. Capturing the virtual space by the virtual camera may mean that: a series of operations are carried out by using the working parameters of the virtual camera and the spatial information of the virtual space as reference information, to obtain an image that can be generated when the virtual camera performs imaging according to the imaging principle of a real camera. This image may be used as the captured image in the virtual space captured by the virtual camera.

Step 140, displaying, in the virtual space, a recognition processing result of a to-be-recognized code in the captured image.

After the captured image is acquired, the captured image may be output to a specific render map, for example to a render map located in a memory of the head-mounted display device.

Next, a rendering engine may be invoked to sample and analyze the render map at a specific frequency, to determine whether a to-be-recognized code is present in the captured image.

If a to-be-recognized code is present in the captured image, recognition may be performed on the to-be-recognized code to obtain a recognition processing result of the to-be-recognized code, and the recognition processing result of the to-be-recognized code may be displayed in the virtual space.

Optionally, if the to-be-recognized code is a to-be-recognized code related to a shopping application, the recognition processing result of the to-be-recognized code may be the application interface of the shopping application; if the to-be-recognized code is a to-be-recognized code related to a website address, the recognition processing result of the to-be-recognized code may be a web page corresponding to the website address; and if the to-be-recognized code is a to-be-recognized code related to payment, the recognition processing result of the to-be-recognized code may be a payment result (e.g., successful or failed payment).

Optionally, the recognition processing result of the to-be-recognized code may be displayed at a preset position in the virtual space; or the recognition processing result of the to-be-recognized code may be displayed at any position in the virtual space specified by the user according to the user's actual need.

In the embodiment of the present disclosure, a to-be-recognized code scanner may be displayed in a virtual space of a head-mounted display device, and with reference to display parameters of the to-be-recognized code scanner, parameter setting may be performed reasonably on a virtual camera corresponding to the to-be-recognized code scanner. By acquiring a captured image in the virtual space captured by the virtual camera with set parameters, and displaying, in the virtual space, a recognition processing result of a to-be-recognized code in the captured image, recognition processing of the to-be-recognized code in the virtual space can be achieved. Hence, in the embodiment of the present disclosure, when the head-mounted display device displays contents, recognition processing of the to-be-recognized code in the contents displayed by the head-mounted display device can be performed efficiently and reliably through the cooperative use of the to-be-recognized code scanner and the virtual camera, thereby satisfying the user's need for recognition processing of the to-be-recognized code, thus improving the user's experience.

Based on the embodiment shown in FIG. 1, before step 110, the method further includes steps 101, 103 and 105, as shown in FIG. 3. Of course, it may be understood that the above-mentioned executor may also directly determine a position where the to-be-recognized code scanner is to be displayed, by a human eye tracking or other method, and then display the to-be-recognized code scanner at the determined position. This is not limited to a single approach.

Step 101, determining an intersection point between a target ray and a target interface in the virtual space.

Optionally, the head-mounted display device may be provided with a handheld controller. A device for collecting pose, attitude or position, such as an inertial measurement unit (IMU), may be provided in the handheld controller. A virtual controller (e.g., a virtual mobile phone) may be provided at a position in the virtual space (the position may be set according to ergonomics). The virtual controller may appear in the user's field of view when the user lowers his/her head, so as to be seen by the user. The user can control displayed contents in the virtual space by manipulating the handheld controller. For example, the user can manipulate the handheld controller to cause the virtual controller to emit a ray or to adjust a direction in which a ray is emitted. It is to be noted that the ray emitted by the virtual controller may serve as the target ray in step 101.

Alternatively, the above-mentioned head-mounted display device may support gesture control operation. In this case, the above-mentioned target ray may be a ray emitted in a direction indicated by the gesture, the above-mentioned target ray may be referred to as a hand ray, and the above-mentioned intersection point may be an intersection point between the hand ray and the target interface in the virtual space.

Optionally, an interface may be provided in the virtual space. The interface may be visible to the user and used for displaying contents. For example, a movie poster, a browser page, etc. may be displayed in the interface. When the head-mounted display device initially displays the virtual space, the interface may be displayed in the virtual space according to a set position, a set size, a set tilt angle, etc. The user may subsequently adjust the position, size, tilt angle, etc. of the interface according to actual needs. It is to be noted that this interface provided in the virtual space may serve as the target interface in step 101.

Step 103, determining a display position of the to-be-recognized code scanner based on the position of the intersection point and a preset distance.

Optionally, the preset distance may be 0.8 meter, 0.1 meter, 0.2 meter or takes another value, which will not be listed here.

In an optional implementation, the display position is located on the target ray, and the distance between the display position and the position of the intersection point may be a preset distance.

The distance between the display position and the head-mounted display device may be less than the distance between the position of the intersection point and the head-mounted display device.

Since the intersection point between the target ray and the target interface is known, a target point may be found between an emission point of the target ray (e.g., a center point of the virtual controller) and the intersection point such that the distance between the target point and the intersection point is the preset distance, and the position where the target point is located may be used as the display position of the to-be-recognized code scanner.

Adopting this implementation to determine the display position of the to-be-recognized code scanner can ensure that the to-be-recognized code scanner is located on the target ray and at a certain distance in front of the position of the intersection point. Since the user can adjust the emission direction of the target ray by manipulating the handheld controller, the user can flexibly adjust the display position of the to-be-recognized code scanner according to actual needs.

Of course, the method for determining the display position of the to-be-recognized code scanner is not limited to this. For example, a midpoint between the intersection point and the emission point of the target ray may be determined on the target ray. If the distance between the midpoint and the intersection point is less than the preset distance, the position of the midpoint may be used as the display position of the to-be-recognized code scanner. If the distance between the midpoint and the intersection point is greater than the preset distance, the display position of the to-be-recognized code scanner may be determined by the method in the above implementation.

Step 105, determining a display orientation of the to-be-recognized code scanner based on at least one of an emission direction of the target ray and an interface orientation of the target interface.

Optionally, a direction that is the same as the interface orientation of the target interface may be determined as the display orientation of the to-be-recognized code scanner, or an orientation that is opposite to the emission direction of the target ray may be determined as the display orientation of the to-be-recognized code scanner.

Thus, in an optional implementation, the display orientation may satisfy one of the two following conditions: the display orientation is the same as the interface orientation; and the display orientation is opposite to the emission direction.

If the display orientation is the same as the interface orientation, the to-be-recognized code scanner and the target interface may be parallel to each other. This helps avoid insertion of the to-be-recognized code scanner into the target interface during display, thereby avoiding an impact on the display effects of the to-be-recognized code scanner and the target interface.

If the display orientation is opposite to the emission direction, a front side of the to-be-recognized code scanner may be considered to face the emission point of the target ray. This allows the user to flexibly adjust the display orientation of the to-be-recognized code scanner according to actual needs.

In the embodiment of the present disclosure, after an intersection point between a target ray and a target interface in the virtual space is determined, a display position of the to-be-recognized code scanner may be determined reasonably with reference to the position of the intersection point and a preset distance, and a display orientation of the to-be-recognized code scanner may be determined reasonably with reference to at least one of an emission direction of the target ray and an interface orientation of the target interface. The determined display position and display orientation may constitute display parameters of the to-be-recognized code scanner. According to the display parameters, the to-be-recognized code scanner may be displayed in the virtual space according to an attitude desired by the user.

In some optional embodiments, a method for displaying information is disclosed, including: rendering displayed contents in a virtual space of a head-mounted display device by a first virtual camera, the displayed contents including a to-be-recognized code; displaying a to-be-recognized code scanner in the virtual space of the head-mounted display device, the to-be-recognized code scanner being configured with a corresponding second virtual camera; receiving a user's adjustment of display parameters of the to-be-recognized code scanner, so as to enable the to-be-recognized code scanner to correspond to a to-be-recognized code; in response to receiving the user's adjustment of the display parameters of the to-be-recognized code scanner, setting parameters of the second virtual camera based on the display parameters of the to-be-recognized code scanner; acquiring a captured image of the displayed contents in the virtual space captured by the second virtual camera with set parameters; and displaying, in the virtual space, a recognition processing result of the to-be-recognized code in the captured image.

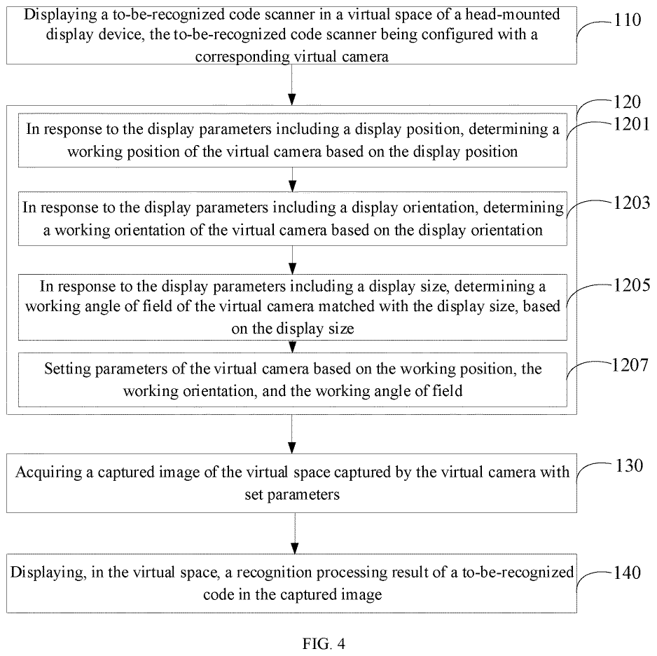

Based on the embodiment shown in FIG. 1, step 120 includes steps 1201, 1203, 1205 and 1207, as shown in FIG. 4.

Step 1201, in response to the display parameters including a display position, determining a working position of the virtual camera based on the display position.

In step 1201, information included in the display parameters may be traversed to determine whether the display parameters include a display position, and if the display parameters include a display position, a working position of the virtual camera may be determined based on the display position.

In an optional implementation, determining a working position of the virtual camera based on the display position includes: determining the display position as the working position.

By adopting this implementation, the virtual camera may be considered to be attached at the same position as the to-be-recognized code scanner, and thus, the virtual camera can also be located on the target ray and at a certain distance in front of the position of the intersection point, and a display position of the virtual camera can also be adjusted flexibly.

Of course, the method of determining the working position of the virtual camera is not limited to this. For example, a position that is deviated from the display position by a certain distance in an up, down, left, right or depth direction may be used as the working position.

Step 1203, in response to the display parameters including a display orientation, determining a working orientation of the virtual camera based on the display orientation.

In step 1203, the information included in the display parameter may be traversed to determine whether the display parameters include a display orientation, and if the display parameters include a display orientation, a working orientation of the virtual camera may be determined based on the display orientation.

In an optional implementation, determining a working orientation of the virtual camera based on the display orientation includes: determining a direction opposite to the display orientation as the working orientation.

By adopting this implementation, the working orientation of the virtual camera may be considered to be opposite to the display orientation. Since the display orientation may be opposite to the emission direction, the working orientation may be considered to be the same as the emission direction, i.e., the virtual camera faces away from the emission point of the target ray, and the virtual camera can capture contents located behind it (the word “behind” here refers to a direction with respect to the user, and the contents include a content at the position of the intersection point between the target ray and the target interface). Thus, if a to-be-recognized code is present at the position of the intersection point, the to-be-recognized code can be included in a captured image obtained by the virtual camera, and subsequently, a recognition processing result of the to-be-recognized code can be displayed in the virtual space.

Of course, the method of determining the working orientation of the virtual camera is not limited to this. For example, a direction deflected by a certain angle from the direction opposite to the display orientation may be used as the working orientation.

Step 1205, in response to the display parameters including a display size, determining a working angle of field of the virtual camera matched with the display size, based on the display size.

In step 1205, the information included in the display parameter may be traversed to determine whether the display parameters include a display size, and if the display parameters include a display size, a working angle of field of the virtual camera matched with the display size may be determined.

In an optional implementation, in the case where the to-be-recognized code scanner is a rectangular scanning frame as shown in FIG. 2-1 or FIG. 2-2, the display size may include a display width and a display height. In the case where the to-be-recognized code scanner is a circular scanning frame, the display size may include a display radius.

It is to be noted that a corresponding relationship between a size range and an angle of field may be pre-set. For example, an angle of field corresponding to a radius range of R1 to R2 may be 100 degrees, an angle of field corresponding to a radius range of R2 to R3 may be 110 degrees, and an angle of field corresponding to a radius range of R3 to R4 may be 120 degrees. Thus, if the display parameters include a display size, a size range to which the display size belongs may be determined first, and then an angle of field corresponding to the size range to which the display size belongs may be determined according to the pre-set corresponding relationship. The determined angle of field may be used as the working angle of field matched with the display size.

Of course, the method of determining the working angle of field of the virtual camera is not limited to this. For example, a function with a size as an independent variable and an angle of field as a dependent variable may be predetermined through experiments. By using the display size of the to-be-recognized code scanner as an input of the function, a corresponding angle of field may be obtained through function computation. This angle of field may be used as the working angle of field.

Step 1207, setting parameters of the virtual camera based on the working position, the working orientation, and the working angle of field.

Optionally, a created virtual camera may have corresponding attributes, including a position attribute, an orientation attribute, an angle of field attribute, etc. In step 1207, an attribute value of the position attribute may be set as the working position determined in step 1201, an attribute value of the orientation attribute may be set as the working orientation determined in step 1203, and an attribute value of the angle of field attribute may be set as the working angle of field determined in step 1205, thus accomplishing parameter setting on the virtual camera. This enables the virtual camera to work according to the working position, the working orientation, and the working angle of field. Of course, alternatively, processing such as correction may be performed first on the working position, the working orientation, and the working angle, and then the processed data such as working position, working orientation, working angle of field may be set correspondingly as parameters of the virtual camera. This is not limited to a single approach here.

In the embodiment of the present disclosure, working parameters of the virtual camera can be reasonably determined with reference to the display parameters of the to-be-recognized code scanner. The working parameters of the camera may include at least one of a working position, a working orientation, and a working angle of field. Parameter setting is performed on the virtual camera according to the working parameters. This can ensure the reasonableness of parameters used during working of the virtual camera, so that the captured image obtained by the virtual camera includes a complete to-be-recognized code.

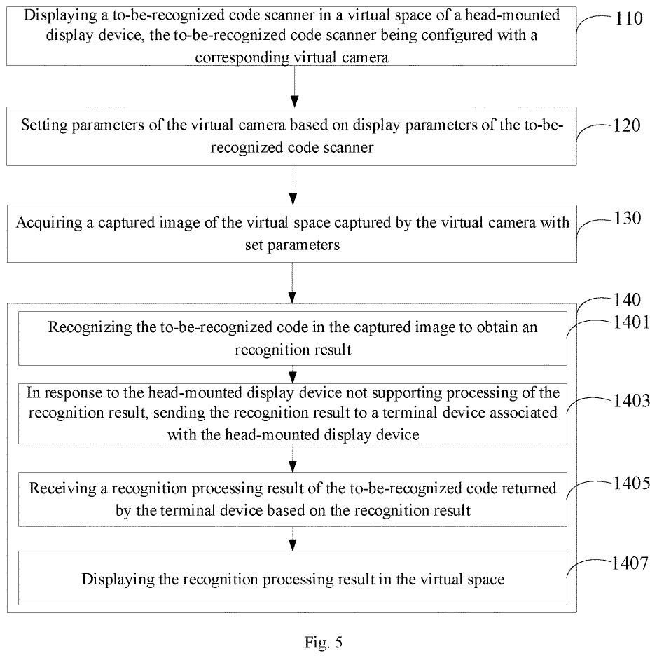

Based on the embodiment shown in FIG. 1, step 140 includes steps 1401, 1403, 1405 and 1407, as shown in FIG. 5.

Step 1401, recognizing the to-be-recognized code in the captured image to obtain a recognition result.

Optionally, if the to-be-recognized code is a to-be-recognized code related to a website address, the recognition result may be the website address; and if the to-be-recognized code is a to-be-recognized code related to payment, the recognition result may be a payment application.

Step 1403, in response to the head-mounted display device not supporting processing of the recognition result, sending the recognition result to a terminal device associated with the head-mounted display device.

In step 1403, whether the head-mounted display device supports processing of the recognition result may be determined.

If the processing of the recognition result requires applying functions such as face recognition, payment, etc., the recognition result may be sent to a terminal device associated with the head-mounted display device, since the head-mounted display device typically does not support these functions. Optionally, the association of the head-mounted display device with the terminal device means that the head-mounted display device and the terminal device may be devices of the same user, and the head-mounted display device and the terminal device are bound to each other in advance. The terminal device includes, but is not limited to, a mobile phone, a tablet computer, etc.

If the processing of the recognition result requires invoking a browser, the head-mounted display device may continue processing the recognition result to obtain and display a corresponding recognition processing result, for example, displaying a web page corresponding to a website address through a browser window, since the head-mounted display device typically supports a browser invoking function.

Step 1405, receiving a recognition processing result of the to-be-recognized code returned by the terminal device based on the recognition result.

Optionally, if the head-mounted display device does not support processing of the recognition result, the head-mounted display device may display “You are about to enter a third-party application. Please complete the operation on your mobile phone” in the virtual space, prompting the user to carry out the operation on the terminal device so as to achieve processing of the recognition result.

If the processing of the recognition result requires applying a face recognition function, the terminal device may invoke a real camera thereof to capture a facial image, and perform recognition on the captured facial image. If the processing of the recognition result requires applying a payment function, the terminal device may redirect to an application interface of a payment application.

After the terminal device obtains a recognition processing result of the to-be-recognized code, the terminal device may return the recognition processing result to the head-mounted display device.

Step 1407, displaying the recognition processing result in the virtual space.

Optionally, if the to-be-recognized code is a to-be-recognized code related to a website address, the to-be-recognized code may be located in a browser window in the target interface. In step 1407, another browser window may be newly created in the target interface, and the recognition processing result may be displayed in the other browser window. Alternatively, the recognition processing result may be directly displayed in the browser window where the to-be-recognized code is located.

Optionally, if the to-be-recognized code is a to-be-recognized code related to payment, the displayed contents in the virtual space may be refreshed after payment is successfully made on the terminal device, so that a payment result is displayed in the virtual space.

In the embodiment of the present disclosure, in the case where the head-mounted display device does not support the recognition result of the to-be-recognized code in the captured image, the recognition result may be processed by the terminal device associated with the head-mounted display device, thereby successfully achieving recognition processing of the to-be-recognized code.

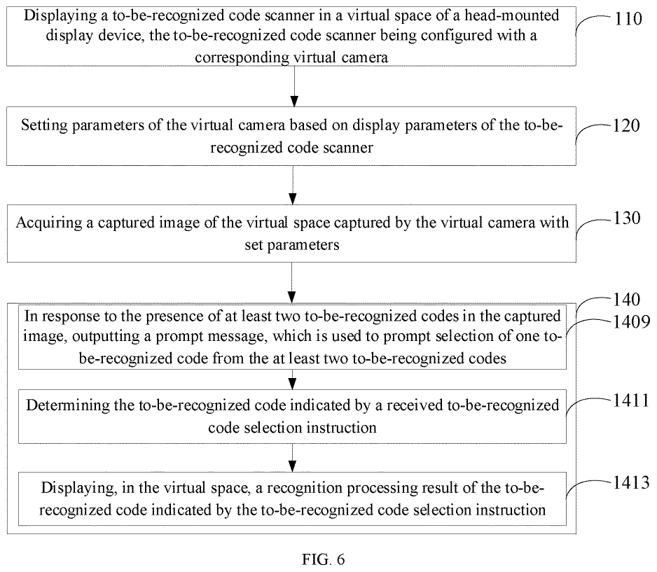

Based on the embodiment shown in FIG. 1, step 140 may further include steps 1409, 1411 and 1413, as shown in FIG. 6.

Step 1409, in response to the presence of at least two to-be-recognized codes in the captured image, outputting a prompt message, which is configured to prompt selection of one to-be-recognized code from the at least two to-be-recognized codes.

After it is determined that a to-be-recognized code is present in the captured image, the number of the to-be-recognized code in the captured image may be determined.

If the number of the to-be-recognized code is one, recognition processing may be performed directly on the to-be-recognized code to obtain a recognition processing result of the to-be-recognized code, and the recognition processing result of the to-be-recognized code may be displayed.

If the number of the to-be-recognized code is at least two (e.g., three), a prompt message may be output. For example, “Please select one two-dimensional code for recognition” may be displayed in the virtual space. Of course, the prompt message may also be in the form of voice or other forms, which will not be listed here.

Step 1411, determining the to-be-recognized code indicated by a received to-be-recognized code selection instruction.

Optionally, the user may initiate the to-be-recognized code selection instruction in step 1411 by manipulating a handheld controller. For example, the user may manipulate the handheld controller to cause a target ray to click on one of the at least two to-be-recognized codes. The to-be-recognized code clicked on by the target ray may be used as the to-be-recognized code indicated by the to-be-recognized code selection instruction. Of course, the to-be-recognized code selection instruction may also be initiated by voice, gesture control (in this case, the head-mounted display device supports gesture control operations) or other methods, which will not be listed here.

Step 1413, displaying, in the virtual space, a recognition processing result of the to-be-recognized code indicated by the to-be-recognized code selection instruction.

In step 1413, recognition processing may be performed on the to-be-recognized code indicated by the to-be-recognized code selection instruction, and a recognition processing result of the to-be-recognized code indicated by the to-be-recognized code selection instruction may be displayed in the virtual space.

In the embodiment of the present disclosure, in the case where at least two to-be-recognized codes are present in the captured image, the user may be prompted, through the output of a prompt message, to select a desired to-be-recognized code from the at least two to-be-recognized codes. Then, recognition processing may be performed only on the to-be-recognized code selected by the user, and a corresponding recognition processing result may be displayed. This can accurately implement recognition processing on the to-be-recognized code desired by the user, and avoid the waste of system resources.

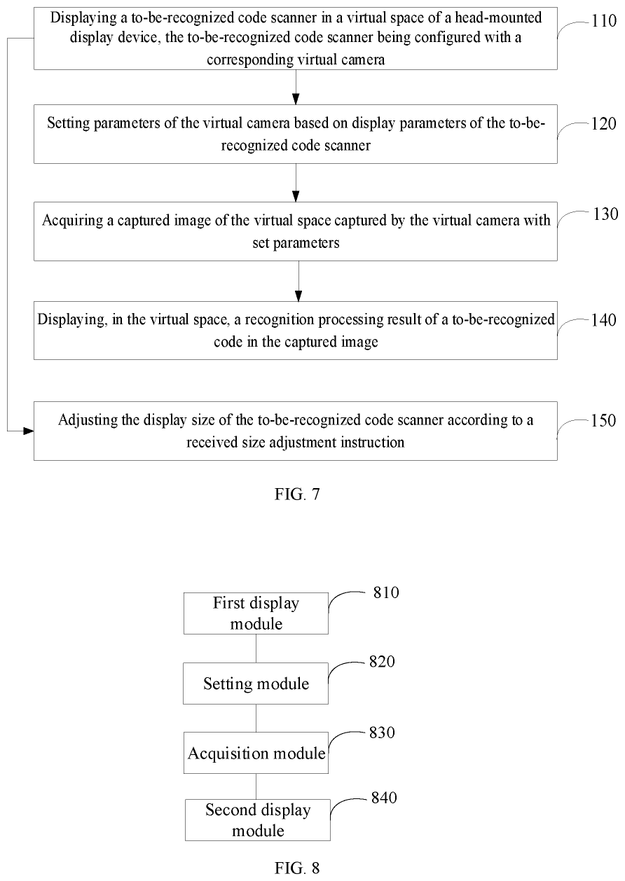

Based on the embodiment shown in FIG. 1, the method further includes step 150, as shown in FIG. 7.

Step 150, adjusting the display size of the to-be-recognized code scanner according to a received size adjustment instruction.

Optionally, the user may initiate the size adjustment instruction in step 150 by manipulating a handheld controller. For example, the user may initiate the size adjustment instruction by performing a left or right swipe operation on the handheld controller. In an optional example, the left swipe operation may be used to initiate a size reduction instruction, and the right swipe operation may be used to initiate a size enlargement instruction. Of course, the size adjustment instructions may also be initiated by voice, gesture control or other methods, which will not be listed here.

In the embodiment of the present disclosure, the display size of the to-be-recognized code scanner may be adjusted flexibly by means of the size adjustment instruction. This enables the display size of the to-be-recognized code scanner to be adapted to the size of the to-be-recognized code, and thereby facilitates adapting the working angle of field of the virtual camera to the size of the to-be-recognized code, so that the captured image obtained by the virtual camera includes a complete to-be-recognized code.

It should be emphasized that, for the head-mounted display device, the displayed contents in the virtual space are obtained through rendering by an original virtual camera. The virtual camera used in the embodiment of the present disclosure is different from the original virtual camera. The virtual camera used in the embodiment of the present disclosure is configured to capture the content at the intersection point between the target ray and the target interface (i.e., to capture the to-be-recognized code) in a scene rendered by the original virtual camera. That is, the area selected by the user for scanning described above refers to an area where the to-be-recognized code is located. In other words, in the case where the above-mentioned head-mounted display device has no scanning camera that can be used to scan a to-be-recognized code such as a two-dimensional code in the virtual space, and a terminal device such as a mobile phone communicatively connected to the head-mounted display device is unable to scan and recognize the to-be-recognized code such as the two-dimensional code, by adopting the solution disclosed in the present application, with respect to the to-be-recognized code such as the two-dimensional code present in an image rendered by the original virtual camera, the above-mentioned executor may create a new virtual camera and demonstrate the same to the user through display of a scanner (i.e., the to-be-recognized code scanner described above), allowing the user to adjust the created new virtual camera based on a display attitude of the scanner, so that the new virtual camera can acquire the to-be-recognized code such as the two-dimensional code rendered by the original virtual camera in the virtual space. Finally, after recognition processing on the captured to-be-recognized code such as two-dimensional code, a recognition processing result may be rendered and displayed in the virtual space by the original virtual camera.

In an optional example, an AR device (equivalent to the head-mounted display device described above) may be provided with a handheld controller, and a virtual controller may be provided at a position in the virtual space of the AR device. Additionally, the AR device may be pre-bound to a mobile phone (equivalent to the terminal device associated with the head-mounted display device described above).

A target interface may be provided in the virtual space of the AR device, with a movie poster of a movie (which is assumed to be a target movie) being displayed in the target interface, and a to-be-recognized code being displayed in a lower right corner of the movie poster (specifically refer to FIG. 2-1).

The user may manipulate the handheld controller to cause the virtual controller to emit a target ray. The target ray and the target interface may have an intersection point. A rectangular scanning frame may be displayed on the target ray 0.1 meters in front of the intersection point (specifically refer to FIG. 2-2). A virtual camera may be attached at the position of the rectangular scanning frame. The virtual camera may capture a scene in front of the virtual camera (i.e., the area selected by the user for scanning). Optionally, a display position and a display orientation of the rectangular scanning frame may be updated every frame.

If the user wishes to watch the target movie, the user may manipulate the handheld controller to adjust an emission direction of the target ray, so that the intersection point between the target ray and the target interface falls exactly on the to-be-recognized code in the lower right corner of the movie poster. At this time, a captured image of the scene in front of the virtual camera, captured by the virtual camera, also includes the to-be-recognized code.

Optionally, the user may enlarge or reduce the rectangular scanning frame by a left or right swipe operation on the handheld controller, to adapt the size of the rectangular scanning frame to the size of the to-be-recognized code.

After obtaining the captured image including the to-be-recognized code, the AR device may recognize the to-be-recognized code in the captured image to obtain a recognition result. Assuming that the recognition result is a payment application with a movie ticket purchase function, since the AR device does not support a payment function, the AR device may communicate with the mobile phone, enabling the mobile phone to process the recognition result, for example, enabling the mobile phone to pay for a movie ticket for the target movie in the payment application. After the payment is successfully made, information for indicating successful payment may be displayed in the virtual space of the AR device. Assuming that the recognition result is a website address of an introduction web page for the target movie, a browser window may be newly created directly in the target interface, and the web page corresponding to the website address may be displayed through the browser window, so that the user learns about the target movie directly through the web page.

In some cases, at least two to-be-recognized codes may be present in the captured image, in which case a prompt message may be output in text form to prompt the user to select a desired to-be-recognized code from the at least two to-be-recognized codes, and subsequently, only the desired to-be-recognized code for the user needs recognition processing, for example, navigating to a specific web page, performing a payment operation, etc.

In summary, in the embodiment of the present disclosure, the user may use a ray (equivalent to the target ray described above) in a virtual 3D scene (equivalent to the virtual space described above) to carry out an interactive operation in the scene. A to-be-recognized code scanner may be attached at a tail end of the ray for display. The to-be-recognized code scanner is used to prompt the user with the scope of an area to be recognized. Furthermore, a virtual camera may be attached at the same position as the to-be-recognized code scanner. The virtual camera may capture an image, and recognition processing is performed on the captured image, thus meeting the user's need to recognize the to-be-recognized code, and improving the user's experience.

Any method for displaying information provided in embodiments of the present disclosure may be executed by any suitable device having data processing capabilities, including, but not limited to a terminal device and a server, etc. Alternatively, any method for displaying information provided in embodiments of the present disclosure may be executed by a processor. For example, the processor executes any method for displaying information mentioned in embodiments of the present disclosure, by calling corresponding instructions stored in a memory. This will not be described here.

Finally, for a to-be-recognized code such as a two-dimensional code in a real space, the above-mentioned executor may scan the same by invoking a camera in a terminal device such as a mobile phone. Then, recognition processing is performed on a scanning result, and finally, a recognition processing result is displayed in the virtual space.

In some optional embodiments, a method for displaying information is disclosed, the method including: rendering displayed contents in a virtual space by a first virtual camera (which may refer to the original virtual camera described above), the displayed contents including a to-be-recognized code; creating a second virtual camera and displaying the second virtual camera in the form of a to-be-recognized code scanner; in response to receiving a user's adjustment of the to-be-recognized code scanner, adjusting parameters of the second virtual camera, to enable the second virtual camera to acquire the to-be-recognized code included in the displayed contents; and displaying a recognition result of the to-be-recognized code in the virtual space.

In some optional embodiments, a method for displaying information is disclosed, the method including: rendering displayed contents in a virtual space by a first virtual camera, the displayed contents including a to-be-recognized code and a to-be-recognized code scanner; creating a second virtual camera and establishing an association relationship between the second virtual camera and the to-be-recognized code scanner; in response to receiving a user's adjustment of display parameters of the displayed to-be-recognized code scanner, adjusting parameters of the second virtual camera, to enable the second virtual camera to acquire the to-be-recognized code included in the displayed contents; displaying a recognition result of the to-be-recognized code in the virtual space.

In some optional embodiments, a method for displaying information is disclosed, the method including: rendering displayed contents in a virtual space by a first virtual camera, the displayed contents including a to-be-recognized code and a to-be-recognized code scanner; creating a second virtual camera and establish a relationship between the second virtual camera and the to-be-recognized code scanner; in response to receiving a user's adjustment of display parameters of the displayed to-be-recognized code scanner, adjusting parameters of the second virtual camera; in response to the to-be-recognized code scanner corresponding to the position of the to-be-recognized code in the displayed contents, acquiring the to-be-recognized code by the second virtual camera; and displaying a recognition result of the to-be-recognized code in the virtual space.

### Exemplary Apparatus

FIG. 8 is an apparatus for displaying information provided in an exemplary embodiment of the present disclosure. The apparatus shown in FIG. 8 includes: a first display module 810 configured to display a to-be-recognized code scanner in a virtual space of a head-mounted display device, the to-be-recognized code scanner being configured with a corresponding virtual camera; a setting module 820 configured to set parameters of the virtual camera based on display parameters of the to-be-recognized code scanner; an acquisition module 830 configured to acquire a captured image of the virtual space captured by the virtual camera with set parameters; and a second display module 840 configured to display, in the virtual space, a recognition processing result of a to-be-recognized code in the captured image.

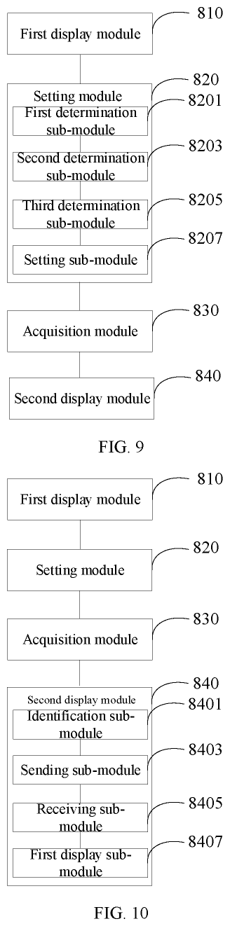

In an optional example, as shown in FIG. 9, the setting module 820 includes: a first determination sub-module 8201 configured to, in response to the display parameters including a display position, determine a working position of the virtual camera based on the display position; a second determination sub-module 8203 configured to, in response to the display parameters including a display orientation, determine a working orientation of the virtual camera based on the display orientation; a third determination sub-module 8205 configured to, in response to the display parameters including a display size, determine a working angle of field of the virtual camera matched with the display size, based on the display size; and a setting sub-module 8207 configured to perform parameter setting on the virtual camera based on the working position, the working orientation, and the working angle of field.

In an optional example, the first determination sub-module 8201 is specifically configured to determine the display position as the working position; and the second determination sub-module 8203 is specifically configured to determine a direction opposite to the display orientation as the working orientation.

In an optional example, as shown in FIG. 10, the second display module 840 includes: a recognition sub-module 8401 configured to recognize the to-be-recognized code in the captured image to obtain a recognition result; a sending sub-module 8403 configured to, in response to the head-mounted display device not supporting processing of the recognition result, send the recognition result to a terminal device associated with the head-mounted display device; a receiving sub-module 8405 configured to receive a recognition processing result of the to-be-recognized code returned by the terminal device based on the recognition result; and a first display sub-module 8407 configured to display the recognition processing result in the virtual space.

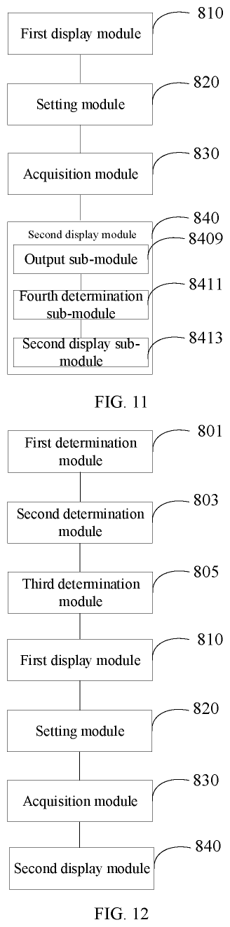

In an optional example, as shown in FIG. 11, the second display module 840 includes: an output sub-module 8409 configured to, in response to the presence of at least two to-be-recognized codes in the captured image, output a prompt message, which is used to prompt selection of one to-be-recognized code from the at least two to-be-recognized codes; a fourth determination sub-module 8411 configured to determine the to-be-recognized code indicated by a received to-be-recognized code selection instruction; and a second display sub-module 8413 configured to display, in the virtual space, a recognition processing result of the to-be-recognized code indicated by the to-be-recognized code selection instruction.

In an optional example, as shown in FIG. 12, the apparatus further includes: a first determination module 801 configured to, before displaying the to-be-recognized code scanner in the virtual space of the head-mounted display device, determine an intersection point between a target ray and a target interface in the virtual space; a second determination module 803 configured to determine a display position of the to-be-recognized code scanner based on the position of the intersection point and a preset distance; and a third determination module 805 configured to determine a display orientation of the to-be-recognized code scanner based on at least one of an emission direction of the target ray and an interface orientation of the target interface.

In an optional example, the display position is located on the target ray, and the distance between the display position and the position of the intersection point is the preset distance; and the distance between the display position and the head-mounted display device is less than the distance between the position of the intersection point and the head-mounted display device.

In an optional example, the display orientation satisfies one of the two following conditions: the display orientation is the same as the interface orientation; and the display orientation is opposite to the emission direction.

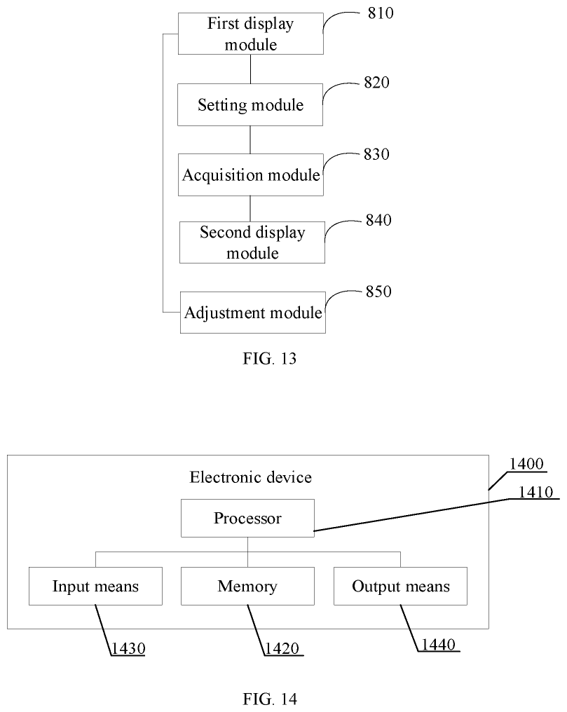

In an optional example, as shown in FIG. 13, the apparatus further includes: an adjustment module 850 configured to adjust the display size of the to-be-recognized code scanner according to a received size adjustment instruction.

### Exemplary Electronic Device

An electronic device according to an embodiment of the present disclosure will be described below with reference to FIG. 14. The electronic device may be either or both of a first device and a second device, or a stand-alone device independent thereof. The stand-alone device may communicate with the first device and the second device to receive collected input signals therefrom.

FIG. 14 illustrates a block diagram of an electronic device 1400 according to an embodiment of the present disclosure.

As shown in FIG. 14, the electronic device 1400 includes one or more processors 1410 and a memory 1420.

The processor 1410 may be a central processing unit (CPU) or other form of processing unit having data processing capabilities and/or instruction execution capabilities, and may control other components in the electronic device 1400 to perform desired functions.

The memory 1420 may include one or more computer program products. The computer program products may include various forms of computer-readable storage medium, such as a volatile memory and/or a non-volatile memory. The volatile memory may, for example, include random access memory (RAM) and/or a cache memory (cache), etc. The non-volatile memory may, for example, include a read-only memory (ROM), a hard disk, a flash memory, etc. One or more computer program instructions may be stored on the computer-readable storage medium, and the processor 1410 may execute the program instructions to implement the method for displaying information in embodiments of the present disclosure described above and/or other desired functions. Various contents such as input signals, signal components, noise components, etc. may also be stored in the computer-readable storage medium.

In an example, the electronic device 1400 may further include input means 1430 and output means 1440. The components are interconnected via a bus system and/or other form of connecting mechanisms (not shown).

For example, in the case where the electronic device 1400 is a first device or a second device, the input means 1430 may be a microphone or a microphone array. In the case where the electronic device 1400 is a stand-alone device, the input means 1430 may be a communication network connector configured to receive collected input signals from the first device and the second device.

In addition, the input means 1430 may also include, for example, a keyboard, a mouse, and the like.

The output means 1440 may output various information to the outside. The output means 1440 may include, for example, a display, a speaker, a printer, and a communications network and remote output means connected thereto, and so on.

Of course, for simplicity, only some of components of the electronic device 1400 relevant to the present disclosure are shown in FIG. 14, while components such as buses, input/output interfaces, and the like are omitted. In addition, depending on a specific application, the electronic device 1400 may further include any other appropriate components.

### Exemplary Computer Program Product and Computer-Readable Storage Medium

In addition to the method and device described above, embodiments of the present disclosure may also be a computer program product including computer program instructions. The computer program instructions, when executed by a processor, cause the processor to execute the steps of the method for displaying information according to various embodiments of the present disclosure as described in the above-described “Exemplary method” section of this specification.

The computer program product may use any combination of one or more programming languages to write program code for performing operations of the embodiments of the present disclosure. The programming languages include an object-oriented programming language such as Java or C++, and also include a conventional procedural programming language, such as “C” language or a similar programming language. The program code may be executed entirely on a user's computing device, partly on a user's device, as an independent software package, partly on a user's computing device and partly on a remote computing device, or entirely on a remote computing device or server.

In addition, embodiments of the present disclosure may also be a computer-readable storage medium configured to store computer program instructions therein. The computer program instructions, when executed by a processor, cause the processor to execute the steps of the method for displaying information according to various embodiments of the present disclosure as described in the above-described “Exemplary method” section of this specification.

The computer-readable storage medium may be any combination of one or more readable media. The readable medium may be a readable signal medium or a readable storage medium. The readable storage medium may include, for example, but is not limited to, an electronic, magnetic, optical, electromagnetic, infrared, or semiconductor system, apparatus or device, or any combination thereof. More specific examples (a non-exhaustive list) of the readable storage medium include: an electrical connection with one or more conducting wires, a portable disk, a hard disk, a random access memory (RAM), a read only memory (ROM), an erasable programmable read only memory (EPROM or flash memory), an optical fiber, a portable compact disk read only memory ((CD-ROM), an optical storage device, a magnetic storage device, or any suitable combination thereof.

Basic principles of the present disclosure are described above in conjunction with specific embodiments. However, it is to be noted that the advantages, strengths, effects, and the like mentioned in the present disclosure are only examples and not limitations, and these advantages, strengths, effects, and the like should not be regarded as indispensable for the embodiments of the present disclosure. In addition, the specific details in the above disclosure are only for the purposes of exemplification and ease of understanding, and are not limiting. The above details do not constrain the present disclosure to be necessarily implemented with the above specific details.

The embodiments in the specification are described in a progressive manner. Each embodiment focuses on differences from other embodiments. For the same and similar parts between the embodiments, reference can be made to each other. A system embodiment, which substantially corresponds to a method embodiment, is described relatively simply, and for its relevant parts, reference may be made to parts of description of the method embodiment.

Block diagrams of devices, apparatuses, equipment, and systems involved in the present disclosure are only used as illustrative examples and are not intended to require or imply that they are necessarily connected, arranged, or configured in the manner illustrated in the block diagrams. As will be recognized by those skilled in the art, these devices, apparatuses, equipment, and systems may be connected, arranged, or configured in any manner. Words such as “include”, “comprise”, “have”, etc. are open-ended terms, mean “include but not limited to” and may be used interchangeably. The words “or” and “and” as used herein refer to the words “and/or”, and may be used interchangeably therewith unless the context clearly indicates otherwise. The word “such as” as used herein refers to the phrase “such as, but not limited to”, and may be used interchangeably therewith.

The method and apparatus of the present disclosure may be implemented in many ways. For example, the method and apparatus of the present disclosure may be implemented by software, hardware, firmware, or any combination of software, hardware, and firmware. The above order for the steps of the described method is only for an illustrative purpose, and the steps of the methods of the present disclosure are not limited to the order specifically described above, unless otherwise specified. Additionally, in some embodiments, the present disclosure may also be implemented as programs recorded in a recording medium. The programs include machine-readable instructions for implementing the method according to the present disclosure. Thus, the present disclosure also covers a recording medium that stores programs for performing the method according to the present disclosure.

It is also to be noted that in the apparatus, device, and method of the present disclosure, the components or steps are decomposable and/or recombinable. These decompositions and/or recombinations should be considered as equivalents of the present disclosure.

The above description of the disclosed aspects is provided to enable any person skilled in the art to carry out or use the present disclosure. Various modifications to these aspects are very apparent to those skilled in the art, and general principles defined herein may be applied to other aspects without departing from the scope of the present disclosure. Accordingly, the present disclosure is not intended to be limited to the aspects illustrated herein, but rather in accordance with the broadest scope consistent with the principles and novel features disclosed herein.

The above description has been made for purposes of illustration and description. In addition, this description is not intended to limit the embodiments of the present disclosure to the forms disclosed herein. Although a plurality of example aspects and embodiments have been discussed above, certain variations, modifications, changes, additions, and sub-combinations thereof would occur to those skilled in the art.

1. A method for displaying information, comprising:
displaying a to-be-recognized code scanner in a virtual space of a head-mounted display device, the to-be-recognized code scanner being configured with a corresponding virtual camera;
setting parameters of the virtual camera based on display parameters of the to-be-recognized code scanner;
acquiring a captured image of the virtual space captured by the virtual camera with set parameters; and
displaying, in the virtual space, a recognition processing result of a to-be-recognized code in the captured image.

2. The method according to claim 1, wherein
the to-be-recognized code scanner is configured to indicate, in an explicit form, an area selected for scanning in displayed contents in the virtual space; and
the virtual camera is configured to capture, in an implicit form, the area selected for scanning.

3. The method according to claim 2, wherein setting the parameters of the virtual camera based on display parameters of the to-be-recognized code scanner comprises:
associating the to-be-recognized code scanner and the virtual camera with the selected area in the displayed contents in the virtual space;
in response to receiving a user's operation of selecting the area for scanning, refreshing the display parameters of the to-be-recognized code scanner and parameters of the virtual camera, and acquiring a refresh result of the parameters of the virtual camera; and
setting the parameters of the virtual camera according to the acquired refresh result.

4. The method according to claim 1, wherein the to-be-recognized code scanner comprises a rectangular scanning frame.

5. The method according to claim 1, wherein
if the to-be-recognized code is a to-be-recognized code related to a shopping application, the recognition processing result of the to-be-recognized code is an application interface of the shopping application;
if the to-be-recognized code is a to-be-recognized code related to a website address, the recognition processing result of the to-be-recognized code is a web page corresponding to the website address; and
if the to-be-recognized code is a to-be-recognized code related to payment, the recognition processing result of the to-be-recognized code is a payment result.

6. The method according to claim 1, wherein setting the parameters of the virtual camera based on display parameters of the to-be-recognized code scanner comprises:
in response to the display parameters comprising a display position, determining a working position of the virtual camera based on the display position;
in response to the display parameters comprising a display orientation, determining a working orientation of the virtual camera based on the display orientation;
in response to the display parameters comprising a display size, determining a working angle of field of the virtual camera matched with the display size, based on the display size; and
setting the parameters of the virtual camera based on the working position, the working orientation, and the working angle of field.

7. The method according to one of claim 6, wherein determining a working position of the virtual camera based on the display position comprises:
determining the display position as the working position; and
determining a working orientation of the virtual camera based on the display orientation comprises:
determining a direction opposite to the display orientation as the working orientation.

8. The method according to claim 1, wherein displaying, in the virtual space, a recognition processing result of a to-be-recognized code in the captured image comprises:
recognizing the to-be-recognized code in the captured image to obtain a recognition result;
in response to the head-mounted display device not supporting processing of the recognition result, sending the recognition result to a terminal device associated with the head-mounted display device;
receiving a recognition processing result of the to-be-recognized code returned by the terminal device based on the recognition result; and
displaying the recognition processing result in the virtual space.

9. The method according to claim 1, wherein displaying, in the virtual space, a recognition processing result of a to-be-recognized code in the captured image comprises:
in response to the presence of at least two to-be-recognized codes in the captured image, outputting a prompt message, which is used to prompt selection of one to-be-recognized code from the at least two to-be-recognized codes;
determining the to-be-recognized code indicated by a received to-be-recognized code selection instruction; and
displaying, in the virtual space, a recognition processing result of the to-be-recognized code indicated by the to-be-recognized code selection instruction.

10. The method according to claim 1, wherein before displaying the to-be-recognized code scanner in the virtual space of the head-mounted display device, the method further comprises:
determining an intersection point between a target ray and a target interface in the virtual space;
determining a display position of the to-be-recognized code scanner based on the position of the intersection point and a preset distance; and
determining a display orientation of the to-be-recognized code scanner based on at least one of an emission direction of the target ray and an interface orientation of the target interface.

11. The method according to claim 10, wherein the display position is located on the target ray, and a distance between the display position and the position of the intersection point is the preset distance; and
a distance between the display position and the head-mounted display device is less than a distance between the position of the intersection point and the head-mounted display device.

12. The method according to claim 10, wherein the display orientation satisfies at least one of the following two conditions:
the display orientation is the same as the interface orientation; and
the display orientation is opposite to the emission direction.

13. The method according to claim 1, further comprising:
adjusting a display size of the to-be-recognized code scanner according to a received size adjustment instruction.

14. An electronic device, comprising:
a memory configured to store a computer program product; and
a processor configured to execute the computer program product stored in the memory, wherein the computer program product, when executed, implements a method for displaying information comprising:
rendering displayed contents in a virtual space by a first virtual camera, the displayed contents comprising a to-be-recognized code;
creating a second virtual camera and displaying the second virtual camera in the form of a to-be-recognized code scanner;
in response to receiving a user's adjustment of the to-be-recognized code scanner, adjusting parameters of the second virtual camera,
acquiring the to-be-recognized code included in the displayed contents by the second virtual camera; and
displaying a recognition result of the to-be-recognized code in the virtual space.

15. A non-volatile computer-readable storage medium, configured to store computer program instructions therein, wherein the computer program instructions, when executed by a processor, implements a method for displaying information comprising:
rendering displayed contents in a virtual space of a head-mounted display device by a first virtual camera, the displayed contents including a to-be-recognized code:
displaying a to-be-recognized code scanner in the virtual space of the head-mounted display device, the to-be-recognized code scanner being configured with a corresponding second virtual camera;
receiving a user's adjustment of display parameters of the to-be-recognized code scanner, so as to enable the to-be-recognized code scanner to correspond to a to-be-recognized code;
in response to receiving the user's adjustment of the display parameters of the to-be-recognized code scanner, setting parameters of the second virtual camera based on the display parameters of the to-be-recognized code scanner;
acquiring a captured image of the displayed contents in the virtual space captured by the second virtual camera with set parameters; and
displaying, in the virtual space, a recognition processing result of the to-be-recognized code in the captured image.

16. The electronic device according to claim 14, wherein
the to-be-recognized code scanner is configured to indicate, in an explicit form, an area selected for scanning in displayed contents in the virtual space; and
the second virtual camera is configured to capture, in an implicit form, the area selected for scanning.

17. The electronic device according to claim 14, wherein before creating a second virtual camera and displaying the second virtual camera in the form of a to-be-recognized code scanner, the method further comprises:
determining an intersection point between a target ray and a target interface in the virtual space;
determining a display position of the to-be-recognized code scanner based on the position of the intersection point and a preset distance; and
determining a display orientation of the to-be-recognized code scanner based on at least one of an emission direction of the target ray and an interface orientation of the target interface.

18. The electronic device according to claim 17, wherein the display position is located on the target ray, and a distance between the display position and the position of the intersection point is the preset distance.

19. The electronic device according to claim 14, wherein
if the to-be-recognized code is related to a shopping application, the recognition result of the to-be-recognized code is an application interface of the shopping application;
if the to-be-recognized code is related to a website address, the recognition result of the to-be-recognized code is a web page corresponding to the website address; and
if the to-be-recognized code is related to payment, the recognition result of the to-be-recognized code is a payment result.

20. The electronic device according to claim 19, wherein
the to-be-recognized code scanner is configured to indicate, in an explicit form, an area selected for scanning in displayed contents in the virtual space; and
the second virtual camera is configured to capture, in an implicit form, the area selected for scanning.
